(19) United States
(12) Patent Application Publication
(10) Pub. No.: US 2002/0196154 A1
(43) Pub. Date: Dec. 26, 2002

(54) Pressure warning system

(76) Inventor: James Neil Butchart, Issaquah, WA (US)

Correspondence Address: James Neil Butchart, 24630 SE 133 Street, Issaquah, WA, 98027-8315, US

(21) Appl. No.: 10/177,969

(22) Filed: Jun. 20, 2002

Related U.S. Application Data
(60) Provisional application No. 60/299,793, filed on Jun. 22, 2001.

(51) Int. Cl. G08B 21/00

(52) U.S. Cl. 340/614; 340/626

(57) ABSTRACT

This is a tire pressure warning system that can be easily installed as an after-market item. The alarm can easily be heard while the vehicle is underway. The shatterproof window of the pressure gauge exposed at the center of the wheel cover enables the driver to quickly check pressure. An adjusting screw on the pressure gauge selects the pressure at which the alarm will sound.

### BACKGROUND OF THE INVENTION

1. Field of the Invention

The invention relates to the production of an audible or visual warning when an internal pressure changes to a selected value. Specifically the invention relates to producing an audible warning when tire pressure drops to a dangerous level.

2. Prior Art

Many instruments are on the market for producing an electrical switching at a selected pressure, but all are too expensive or bulky to mount one on each wheel of a vehicle. This invention uses an ordinary mass produced Bourdon type pressure gauge, modified by the addition of an internal adjustable switch. None of the prior patents relating to tire pressure warning devices utilize a pressure gauge for direct pressure readout.

### SUMMARY OF THE INVENTION

Vehicle drivers will have a visual readout of tire pressure, with the gauge window showing through the center of each wheel over. When a tire leak occurs, a piezo alarm, bonded underneath the wheel cover, gives the driver a timely alarm. The gauge is modified by addition of an internal switch and adjusting screw, allowing the user to pre-select the pressure at which the alarm will sound. The convenience of a pressure gauge at each wheel will encourage frequent checking of the tire pressure.

### BRIEF DESCRIPTION OF THE DRAWINGS

FIG. 1 is the pressure gauge, minus the mechanism for moving the dial pointer. Also shown, the two-cell battery, a piezo alarm, an attaching device for tapping the pressure inside the tire valve, and a flexible hose to connect the tire valve to the gauge.

FIG. 2 is an alternate device for attaching the flexible hose to the tire valve.

### DETAILED DESCRIPTION

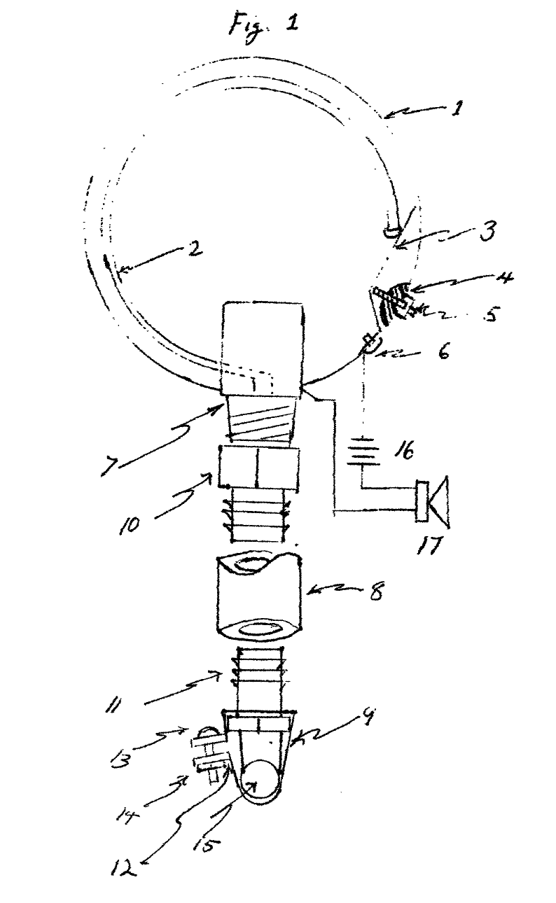

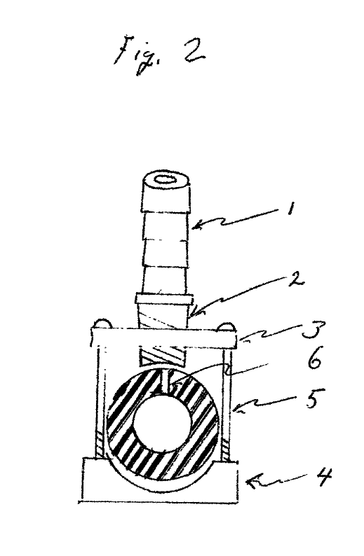

FIG. 1, item 1, is the plastic (ABS) meter case. If a metal case is used extra insulation problems ensue. Item 2 is the brass Bourdon Tube, whose tip moves away from the contactor, item 3, as the pressure increases. The contactor is a strip of brass, ¼″ wide and 0.005″ thick, bent into the shape as shown. The contact strip is drilled at one end to accept the electrical bonding screw, 6. A bead of epoxy is bonded inside the case at 4. The epoxy bead is drilled and tapped for an adjusting set screw, 5. A nut at 5 secures the setting of the screw. The electrical wires attach to the brass fitting, 7, and to the bonding screw, 6. The flexible hose, 8, is for connecting the gauge to the tire valve, 15. 9 is a removable clamp, so that the tube can be slipped off the tire valve, 15, for tire servicing. The valve clamp is made from stainless steel strap, 0.020″ by ⅝″. Items 13 and 14 are the screws and nuts to secure the clamp to the tire valve, 15. Symbolically shown is the 9 volt battery, 16, and the piezo alarm, 17. Item 10 is a ¼″. by ¼″ barbed adopter. Brass adopter 10, is ¼ barb to ⅛″ pipe thread. The threaded end is cut to a radius to fit the tire valve. 12 indicates four points where the strap is flanged and welded for stiffening. FIG. 2 is an alternate attaching method, however some wheel contours will not have room for this attachment. In FIG. 2, item 1 is a brass barbed adopter with the ⅛″ pipe thread end contoured to the radius of the tire valve, 6. Item 3 is a ⅛″ by ⅝″ bar, drilled and tapped for the ¼″ pipe threads, 2. Item 4 is ¼″ diameter aluminum bar, contoured for the valve stem and drilled and tapped for the screws, 5. Item 6 is a ⅙″ diameter hole drilled in the valve stem, 2.

At installation the installer will deflate the tire to the pressure at which a warning is desired. Then he will turn the adjusting screw clockwise until the alarm sounds. Then they will inflate the tire to operating pressure. The light contact pressure of item 3 against the tip of the Bourdon Tube, 2, is adequate for the few milliamps necessary to operate many piezo alarms, however for heavy currents a sensitive relay would be required. Likewise, in a different application, a normally closed relay would be necessary, to use this modified meter to signal over-pressure. A hole is cut in the center of the wheel cover where the pressure gauge is bonded. The piezo alarm and 9 volt battery are bonded under the wheel cover at points to assist balancing the other fittings. A soft bonding agent is used so that it can be cut away for replacement of the battery. On custom wheels that do not use a wheel cover, a molded plastic will be provided to accept the components.

1. A modification to a standard Bourdon type pressure gauge, allowing circuit closure when the internal pressure drops. The warning circuit closes when the tip of the Bourdon Tube moves against the switch. Using the Bourdon Tube as part of the electrical circuit is thought by the inventor to be original. Secondarily, the use of this modified meter in an over-pressure application, by adding a normally closed relay and its contacts turning on the alarm, which can be either a horn or a light.

2. The use of this meter on a wheel cover along with an audio alarm and a battery to give the driver warning when tire pressure drops. Devices for securely connecting the pressure gauge air hose to the tire valve, in a manner that will allow quick separation from the valve stem when tire servicing is required.
